(19) United States
(12) Patent Application Publication
(10) Pub. No.: US 2021/0025129 A1
(43) Pub. Date: Jan. 28, 2021

(54) VALVE CONFIGURATION FOR FRONT END LOADERS

(71) Applicant: Deere & Company, Moline, IL (US)

(72) Inventors: Aaron R. Kenkel, East Dubuque, IL (US); Doug M. Lehmann, Durango, IA (US); Scott R. Stahle, Dubuque, IA (US); Grant R. Henn, Dubuque, IA (US)

(21) Appl. No.: 16/522,113

(22) Filed: Jul. 25, 2019

(51) Int. Cl. E02F 9/08; F16K 11/07; F16K 3/34; F16K 1/54

(52) U.S. Cl. CPC E02F 9/0875; F16K 1/54; F16K 3/34; F16K 11/0712

(57) ABSTRACT

An actuator is connected to a frame and a boom arm to pivot the boom arm with respect to the frame. A spool valve directs fluid from a pump into a selected side of the actuator. A first anti-cavitation valve is fluidly positioned between the first end of the actuator and the reservoir to permit fluid flow from the reservoir to the first end of the actuator while the first anti-cavitation valve is open and inhibit fluid flow from the first end of the actuator to the reservoir. A second anti-cavitation valve is fluidly positioned between the second end of the actuator and the reservoir to permit fluid flow from the reservoir to the second end of the actuator while the second anti-cavitation valve is open and inhibit fluid flow from the second end of the actuator to the reservoir.

### BACKGROUND

The present disclosure relates to front end loaders.

### SUMMARY

In one embodiment, the disclosure provides a material handling vehicle including a vehicle frame, and a boom arm having a first end and a second end. The boom arm is connected to the frame adjacent the first end for rotation with respect to the frame. An actuator is connected to the vehicle frame and the boom arm for moving the boom arm with respect to the frame. The actuator includes a first side and a second side. An attachment is connected to the boom arm adjacent the second end of the boom arm. A fluid reservoir is fluidly connected to the actuator. A pump is fluidly connected to the fluid reservoir and to the actuator to direct fluid from the fluid reservoir into the actuator. A spool valve is fluidly positioned between the pump and the actuator to selectively direct fluid from the pump into the first side of the actuator while the spool valve is in a first position and to direct fluid from the pump into the second side of the actuator while the spool valve is in a second position. A first anti-cavitation valve is fluidly positioned between the first end of the actuator and the reservoir. The first anti-cavitation valve permits fluid flow from the reservoir to the first end of the actuator while the first anti-cavitation valve is open and inhibits fluid flow from the first end of the actuator to the reservoir. A second anti-cavitation valve is fluidly positioned between the second end of the actuator and the reservoir. The second anti-cavitation valve permits fluid flow from the reservoir to the second end of the actuator while the second anti-cavitation valve is open and inhibits fluid flow from the second end of the actuator to the reservoir.

In one embodiment, the disclosure provides a material handling vehicle including a vehicle frame, and a boom arm having a first end and a second end. The boom arm is connected to the frame adjacent the first end for rotation with respect to the frame. A first actuator is connected to the vehicle frame and the boom arm for moving the boom arm with respect to the frame. The first actuator includes a first side and a second side. An attachment is connected to the boom arm adjacent the second end of the boom arm. A second actuator is connected to the boom arm and the attachment. The second actuator includes a first side and a second side. A fluid reservoir is fluidly connected to the first actuator and to the second actuator. A pump is fluidly connected to the fluid reservoir, to the first actuator and to the second actuator. The pump directs fluid from the fluid reservoir into the first actuator and into the second actuator. A first spool valve is fluidly positioned between the pump and the first actuator to selectively direct fluid from the pump into the first side of the first actuator while the first spool valve is in a first position and to direct fluid from the pump into the second side of the first actuator while the first spool valve is in a second position. A second spool valve is fluidly positioned between the pump and the second actuator to selectively direct fluid from the pump into the first side of the second actuator while the second spool valve is in a first position and to direct fluid from the pump into the second side of the second actuator while the second spool valve is in a second position. A first anti-cavitation valve is fluidly positioned between the first side of the first actuator and the reservoir. The first anti-cavitation valve permits fluid flow from the reservoir into the first side of the first actuator while the first anti-cavitation valve is open and inhibits fluid flow from the first side of the first actuator to the reservoir. A second anti-cavitation valve is fluidly positioned between the second end of the actuator and the reservoir. The second anti-cavitation valve permits fluid flow from the reservoir to the second end of the actuator while the second anti-cavitation valve is open and inhibits fluid flow from the second end of the actuator to the reservoir.

In another embodiment the disclosure provides a boom arm assembly that is pivotally connected to a material handling vehicle having a vehicle frame. The boom arm assembly includes a boom arm having a first end and a second end. The boom arm is connected to the frame adjacent the first end for rotation with respect to the frame. An actuator is connected to the vehicle frame and the boom arm for moving the boom arm with respect to the frame. The actuator includes a first side and a second side. A fluid reservoir is fluidly connected to the actuator. A pump is fluidly connected to the fluid reservoir and to the actuator to direct fluid from the fluid reservoir into the actuator. A first valve is fluidly positioned between the pump and the actuator to selectively direct fluid from the pump into the first side of the actuator while the first valve is in a first position and to direct fluid from the pump into the second side of the actuator while the first valve is in a second position. A second valve is fluidly positioned between the first side of the actuator and the reservoir to permit fluid flow from the reservoir into the first side of the actuator while the second valve is open and to inhibit fluid flow from the first side of the actuator to the reservoir. A third valve is fluidly positioned between the second side of the actuator and the reservoir to permit fluid flow from the reservoir into the second side of the actuator while the third valve is open and to inhibit fluid flow from the second side of the actuator to the reservoir.

Other aspects of the disclosure will become apparent by consideration of the detailed description and accompanying drawings.

### BRIEF DESCRIPTION OF THE DRAWINGS

FIG. 1 is a side view of a four wheel drive loader with an attachment in a first position.

FIG. 2 is a side view of the four wheel drive loader of FIG. 1 with an attachment in a second position.

FIG. 3 is a schematic view of the hydraulic system of the attachment according to some embodiments.

FIG. 4 is a side view of the four wheel drive loader of FIG. 1 in which the attachment is against a hard stop.

FIG. 5 is a side view of the four wheel drive loader of FIG. 4 in which the attachment is raised in response to the attachment hard stop.

FIG. 6 is a side view of the four wheel drive loader of FIGS. 4 and 5 in which the attachment is lowered in response to a pressure relief mechanism.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

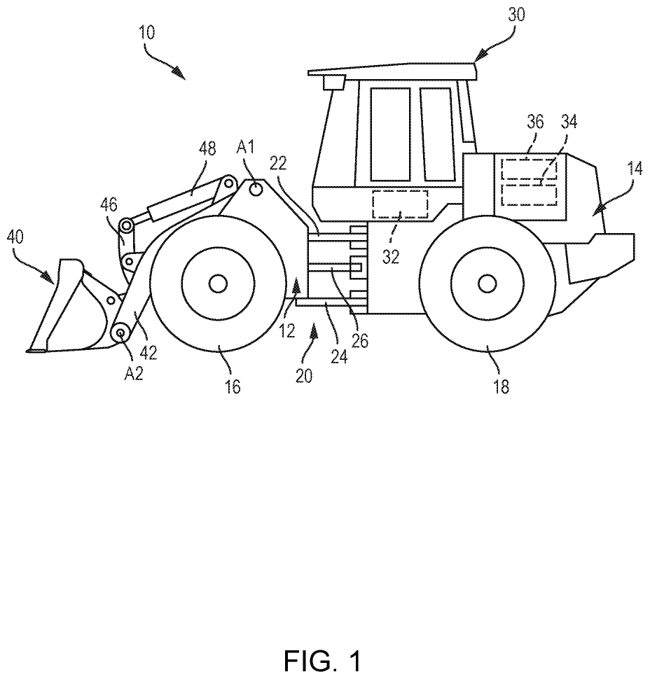

FIG. 1 shows a wheel loader 10 having a front body section 12 with a front frame and a rear body section 14 with a rear frame. The front body section 12 includes a set of front wheels 16 and the rear body section 14 includes a set of rear wheels 18, with one front wheel 16 and one rear wheel 18 positioned on each side of the loader 10. Different embodiments can include different ground engaging members, such as treads or tracks.

The front and rear body sections 12, 14 are connected to each other by an articulation connection 20 so front and rear body sections 12, 14 can pivot in relation to each other about a vertical axis (orthogonal to the direction of travel and the wheel axis). The articulation connection 20 includes one or more upper connection arms 22, one or more lower connection arms 24, and a pair of articulation cylinders 26 (one shown), with one articulation cylinder 26 on each side of the loader 10. Pivoting movement of the front body 12 is achieved by extending and retracting the piston rods in the articulation cylinders 26.

The rear body section 14 includes an operator cab 30 in which the operator controls the loader 10. A user interface 32 is positioned in the cab 30 and can include different combinations of a steering wheel, control levers, joysticks, control pedals, and control buttons. The operator can actuate one or more controls of the user interface 32 for purposes of operating movement of the loader 10 and the different loader components. The rear body section 14 also contains a prime mover 34 and a control system 36. The prime mover 34 can include an engine, such as a diesel engine and the control system 36 can include a vehicle control unit (VCU).

A work implement 40 is moveably connected to the front body section 12 by one or more boom arms 42. The work implement 40 is used for handling and/or moving objects or material. In the illustrated embodiment, the work implement 40 is depicted as a bucket, although other implements, such as a fork assembly, can also be used. One boom arm 42 can be positioned on each side of the work implement 40. Only a single boom arm 42 is shown in the provided side views and referred to herein as the boom 42. The illustrated boom 42 is pivotably connected to the frame of the front body section 12 about a first pivot axis A1 and the illustrated work implement 40 is pivotably connected to the boom 42 about a second pivot axis A2.

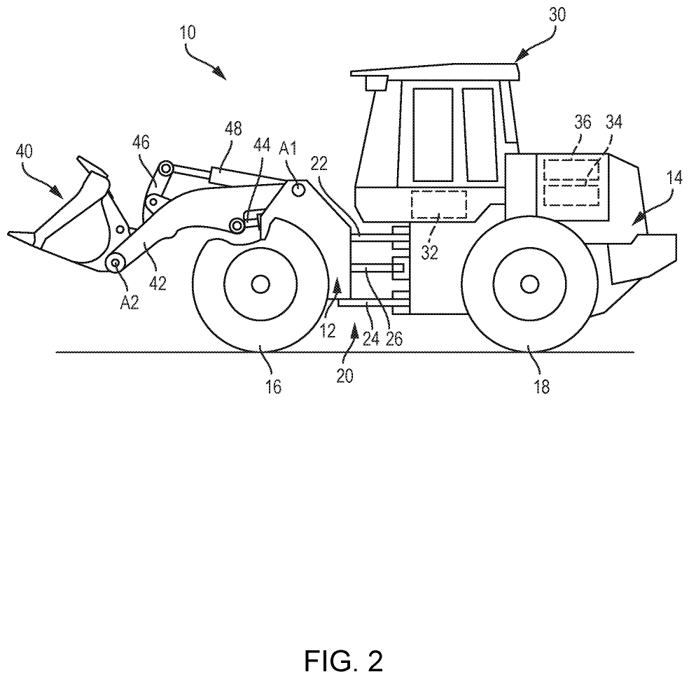

As best shown in FIG. 2, one or more boom hydraulic cylinders 44 are mounted to the frame of the front body section 12 and connected to the boom 42. Generally, two hydraulic cylinders 44 are used with one on each side connected to each boom arm, although the loader 10 may have any number of boom hydraulic cylinders 44, such as one, three, four, etc. The boom hydraulic cylinders 44 can be extended or retracted to raise or lower the boom 42 and thus adjust the vertical position of the work implement 40 relative to the front body section 12.

With reference to FIGS. 1 and 2, one or more pivot linkages 46 are connected to the work implement 40 and to the boom 42. One or more pivot hydraulic cylinders 48 are mounted to the boom 42 and connect to a respective pivot linkage 46. Generally, two pivot hydraulic cylinders 48 are used with one on each side connected to each boom arm, although the loader 10 may have any number of pivot hydraulic cylinders 48. The pivot hydraulic cylinders 48 can be extended or retracted to rotate the work implement 40 about the second pivot axis A2. In some embodiments, the work implement 40 may be moved in different manners and a different number or configuration of hydraulic cylinders or other actuators may be used.

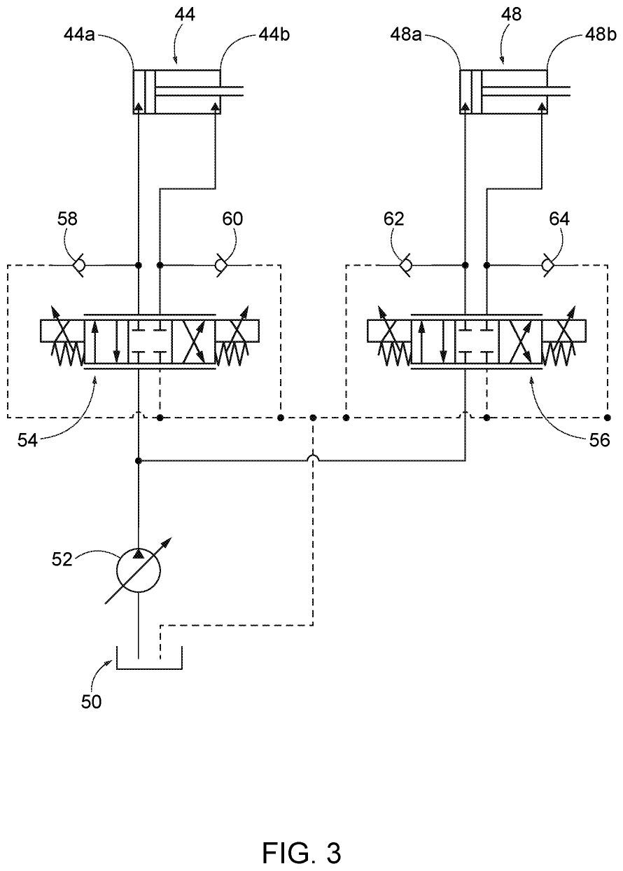

FIG. 3 illustrates one possible hydraulic schematic for the boom hydraulic cylinders 44 and the pivot hydraulic cylinders 48. Only one of the boom hydraulic cylinders 44 and only one of the pivot hydraulic cylinders 48 is shown, but the remaining cylinders 44 and 48 can be provided with corresponding hydraulic schematics. FIG. 3 illustrates a reservoir 50, a pump 52, a first control valve 54, a second control valve 56, a first anti-cavitation valve 58, a second anti-cavitation valve 60, a third anti-cavitation valve 62 and a fourth anti-cavitation valve 64. The boom hydraulic cylinder 44 includes a head side 44a and a piston side 44b, and the pivot hydraulic cylinder 48 includes a head side 48a and a piston side 48b.

The first control valve 54 is fluidly positioned between the pump 52 and the boom hydraulic cylinder 44 to permit flow from the reservoir 50 to the boom hydraulic cylinder 44 via the pump 52 in a first position and to permit flow from the boom hydraulic cylinder 44 to the reservoir 50 in a second position. The first control valve 54 is controlled by the user via the user interface 32 (see FIGS. 1-2).

The second control valve 56 is fluidly positioned between the pump 52 and the pivot hydraulic cylinder 48 to permit flow from the reservoir 50 to the pivot hydraulic cylinder 48 via the pump 52 in a first position and to permit flow from the pivot hydraulic cylinder 48 to the reservoir 50 in a second position. The second control valve 56 is controlled by the user via the user interface 32 (see FIGS. 1-2).

The first anti-cavitation valve 58 is fluidly positioned between the reservoir 50 and the head side 44a of the boom hydraulic cylinder 44. The illustrated first anti-cavitation valve 58 is a check valve, but could be a pressure relief valve, a solenoid valve or other suitable valve that selectively permits flow of fluid from the reservoir 50 to the head side 44a of the boom hydraulic cylinder 44 at a first set point pressure.

The second anti-cavitation valve 60 is fluidly positioned between the reservoir 50 and the piston side 44b of the boom hydraulic cylinder 44. The illustrated second anti-cavitation valve 60 is a check valve, but could be a pressure relief valve, a solenoid valve or other suitable valve that selectively permits flow of fluid from the reservoir 50 to the piston side 44b of the boom hydraulic cylinder 44 at a second set point pressure.

The third anti-cavitation valve 62 is fluidly positioned between the reservoir 50 and the head side 48a of the pivot hydraulic cylinder 48. The illustrated third anti-cavitation valve 62 is a check valve, but could be a pressure relief valve, a solenoid valve or other suitable valve that selectively permits flow of fluid from the reservoir 50 to the head side 48a of the pivot hydraulic cylinder 48 at a third set point pressure.

The fourth anti-cavitation valve 64 is fluidly positioned between the reservoir 50 and the piston side 48b of the pivot hydraulic cylinder 48. The illustrated third anti-cavitation valve 64 is a check valve, but could be a pressure relief valve, a solenoid valve or other suitable valve that selectively permits flow of fluid from the reservoir 50 to the piston side 48b of the pivot hydraulic cylinder 48 at a fourth set point pressure.

There are certain scenarios during which the work implement 40 and/or the boom 42 can be inhibited from moving by one or more software or physical stops. In other words, the linkage design may intentionally have stops built in that limit the ability for the work implement 40 to reach full cylinder stroke. These scenarios may be overcome when the boom 42 reaches a certain height, by allowing the pivot cylinder 48 to fully extend or retract to permit movement of the work implement 40 before hitting a built-in stop. Booms 42 and work implements 40 can be designed in this manner to optimize certain performance characteristics, like parallelism, breakout forces, or visibility. However, this behavior can be undesirable in certain scenarios.

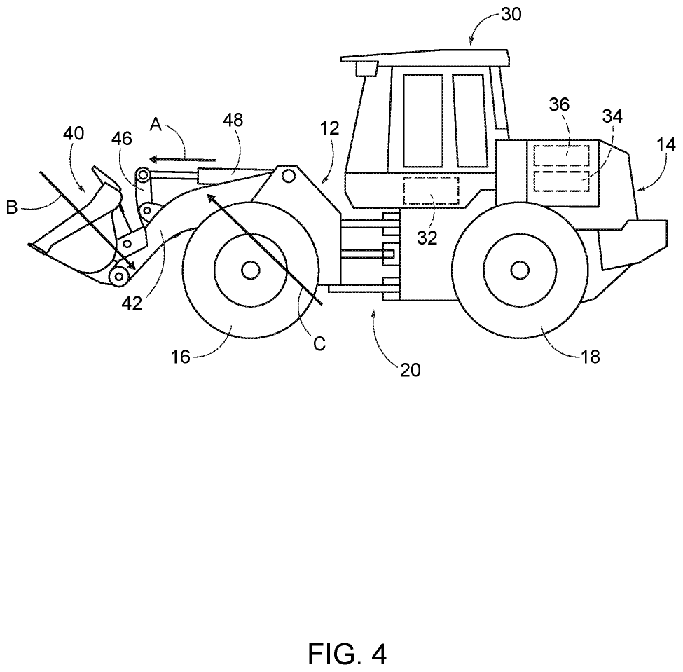

FIG. 4 illustrates one possible scenario in which at least one of the anti-cavitation valves 58, 60, 62 and 64 can be utilized. This scenario can arise when the user extends the pivot cylinder 48 and the work implement 40 is against a stop (either software or physical). The force extending the pivot cylinder 48 is shown as arrow A. The extending pivot cylinder 48 is inhibited from moving the work implement 40 backward by the stop. The force exerted by the work implement 40 against the stop is shown as arrow B. Since the work implement 40 is inhibited from moving, the resulting upward force against the boom 42 is shown as arrow C.

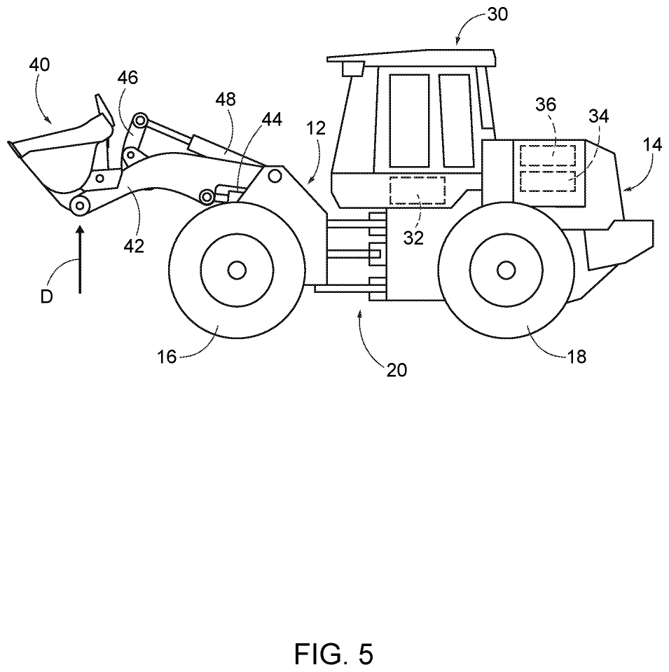

FIG. 5 illustrates the work implement 40 exerting enough force on the stop that the force is capable of lifting the boom 42 upwards. The resulting upward movement against the boom 42 is shown as arrow D. In this scenario, sufficient fluid is not provided to the head side 44a of the boom cylinder 44 because the force B lifts the boom 42 instead of fluid pressure on the head side 44a of the boom cylinder 44.

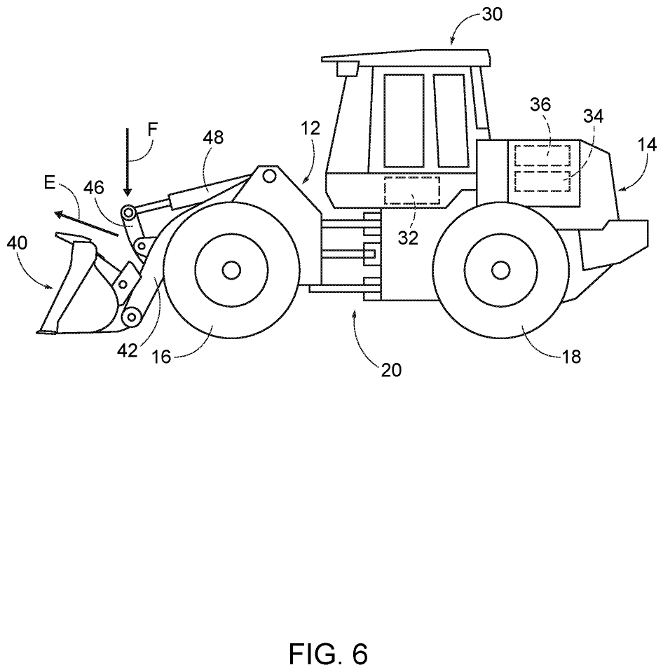

FIG. 6 illustrates that the work implement 40 is pivoted to thereby relieve the force B induced by the work implement 40 abutting against the stop. The pivoting force of the work implement 40 is shown by arrow E. When the user pivots the work implement 40, the force C is removed and the boom cylinder 44 cannot adequately support the boom 42. The force of gravity F lowers the boom 42 back down without the user's command.

In present disclosure, the first anti-cavitation valve 58 permits fluid to be drawn into the head side 44a of the boom cylinder 44 in the scenario shown in FIGS. 4-6 to thereby avoid unintentional lowering of the boom 42. Therefore, the force A in FIG. 4, instead of causing the force C to raise the boom 42, draws fluid from the reservoir 50, through the first anti-cavitation valve 58 and into the head side 44a of the boom cylinder 44. Therefore, even when the force B of the work implement 40 against a stop and the resulting force C raises the boom 42 as shown by arrow D, when the work implement 40 is pivoted such that the force B is replaced by the force E, the boom cylinder 44 retains the boom 42 in the raised position against the force of gravity F. The first anti-cavitation valve 58 increases the stability and reliability of the loader 10 since the boom 42 is supported by the boom cylinder 44 even if the stops (software or physical) inhibit movement of the boom 42 and/or work implement 40.

Similarly, the second anti-cavitation valve 60 permits fluid to flow from the reservoir 50 to the piston side 44b of the boom cylinder 44 in response to a drop in pressure in the piston side 44b of the boom cylinder 44. For example, when the work implement 40 is lowered, the piston side 44b of the boom cylinder 44 can experience a drop in pressure because gravity pulls the work implement 40 downward. In this scenario, the second anti-cavitation valve 60 permits fluid to be drawn into the piston side 44b of the boom cylinder 44 in response to a pressure drop in the piston side 44b of the boom cylinder 44 caused by the force of gravity acting on the work implement 40.

Additionally, the third anti-cavitation valve 62 permits fluid to flow from the reservoir 50 to the head side 48a of the pivot cylinder 48 in response to a drop in pressure in the head side 48a of the pivot cylinder 48. For example, if a heavy load is emptied from the work implement 40, the change in force could retract the pivot cylinder 48 unexpectedly. In this scenario, the third anti-cavitation valve 62 permits fluid to be drawn from the reservoir 50, to the head side 48a of the pivot cylinder 48 to inhibit unintended movement of the pivot cylinder 48 in response to changing forces on the pivot cylinder 48.

Finally, the fourth anti-cavitation valve 64 can permit fluid to be drawn into the piston side 48b of the pivot cylinder 48 in response to a relatively low pressure in the pivot cylinder 48. For example, if a heavy load is lifted with the work implement 40, the change in force could extend the pivot cylinder 48 unexpectedly. In this scenario, the fourth anti-cavitation valve 64 permits fluid to be drawn from the reservoir 50, to the piston side 48b of the pivot cylinder 48 to inhibit unintended movement of the pivot cylinder 48 in response to changing forces on the pivot cylinder 48.

The first, second, third and fourth anti-cavitation valves 58, 60, 62, and 64 work together to enhance the stability and reliability of the loader 10 by permitting the cylinders 44 and 48 to draw fluid from the reservoir 50 into the respective side 44a, 44b, 48a, 48b of the respective cylinder 44 and 48 when the respective side 44a, 44b, 48a, 48b has a reduced pressure.

What is claimed is:

1. A material handling vehicle comprising:
a vehicle frame;
a boom arm having a first end and a second end, the boom arm connected to the frame adjacent the first end for rotation with respect to the frame;
an actuator connected to the vehicle frame and the boom arm for moving the boom arm with respect to the frame, the actuator including a first side and a second side;
an attachment connected to the boom arm adjacent the second end of the boom arm;
a reservoir fluidly connected to the actuator;
a pump fluidly connected to the reservoir and to the actuator, the pump configured to direct fluid from the reservoir into the actuator;
a spool valve fluidly positioned between the pump and the actuator to selectively direct fluid from the pump into the first side of the actuator while the spool valve is in a first position and to direct fluid from the pump into the second side of the actuator while the spool valve is in a second position;
a first anti-cavitation valve fluidly positioned between the first end of the actuator and the reservoir, the first anti-cavitation valve configured to permit fluid flow from the reservoir to the first end of the actuator while the first anti-cavitation valve is open and to inhibit fluid flow from the first end of the actuator to the reservoir; and
a second anti-cavitation valve fluidly positioned between the second end of the actuator and the reservoir, the second anti-cavitation valve configured to permit fluid flow from the reservoir to the second end of the actuator while the second anti-cavitation valve is open and to inhibit fluid flow from the second end of the actuator to the reservoir.

2. The material handling vehicle of claim 1, wherein the first anti-cavitation valve is a check valve and is fluidly connected to a head side of the actuator.

3. The material handling vehicle of claim 1, wherein the actuator is a first actuator and further comprising a second actuator connected to the boom arm and to the attachment, the second actuator configured to pivot the attachment with respect to the boom arm, the second actuator including a first side and a second side.

4. The material handling vehicle of claim 3, wherein the spool valve is a first spool valve and further compromising a second spool valve fluidly connected to the pump, the reservoir and to the second actuator.

5. The material handling vehicle of claim 3, further comprising a third anti-cavitation valve fluidly positioned between the first end of the second actuator and the reservoir and a fourth anti-cavitation valve fluidly positioned between the second end of the second actuator and the reservoir.

6. The material handling vehicle of claim 1, wherein the first anti-cavitation valve opens in response to a negative pressure in the first end of the actuator such that fluid from the reservoir is drawn toward the first end of the actuator through the first anti-cavitation valve by the negative pressure in the first end of the actuator.

7. The material handling vehicle of claim 6, wherein the second anti-cavitation valve opens in response to a negative pressure in the second end of the actuator such that fluid from the reservoir is drawn toward the second end of the actuator through the second anti-cavitation valve by the negative pressure in the second end of the actuator.

8. The material handling vehicle of claim 1, wherein the first anti-cavitation valve is fluidly connected to the first end of the actuator in parallel with the spool valve, and wherein the second anti-cavitation valve is fluidly connected to the second end of the actuator in parallel with the spool valve.

9. A material handling vehicle comprising:
a vehicle frame;
a boom arm having a first end and a second end, the boom arm connected to the frame adjacent the first end for rotation with respect to the frame;
a first actuator connected to the vehicle frame and the boom arm for moving the boom arm with respect to the frame, the first actuator including a first side and a second side;
an attachment connected to the boom arm adjacent the second end of the boom arm;
a second actuator connected to the boom arm and the attachment, the second actuator including a first side and a second side;
a reservoir fluidly connected to the first actuator and to the second actuator;
a pump fluidly connected to the reservoir, to the first actuator and to the second actuator, the pump configured to direct fluid from the reservoir into the first actuator and into the second actuator;
a first spool valve fluidly positioned between the pump and the first actuator to selectively direct fluid from the pump into the first side of the first actuator while the first spool valve is in a first position and to direct fluid from the pump into the second side of the first actuator while the first spool valve is in a second position;
a second spool valve fluidly positioned between the pump and the second actuator to selectively direct fluid from the pump into the first side of the second actuator while the second spool valve is in a first position and to direct fluid from the pump into the second side of the second actuator while the second spool valve is in a second position;
a first anti-cavitation valve fluidly positioned between the first side of the first actuator and the reservoir, the first anti-cavitation valve configured to permit fluid flow from the reservoir into the first side of the first actuator while the first anti-cavitation valve is open and to inhibit fluid flow from the first side of the first actuator to the reservoir; and
a second anti-cavitation valve fluidly positioned between the second end of the first actuator and the reservoir, the second anti-cavitation valve configured to permit fluid flow from the reservoir to the second end of the first actuator while the second anti-cavitation valve is open and to inhibit fluid flow from the second end of the first actuator to the reservoir.

10. The material handling vehicle of claim 9, wherein the first anti-cavitation valve is fluidly connected to the first end of the first actuator in parallel with the first spool valve and wherein the second anti-cavitation valve is fluidly connected to the second end of the first actuator in parallel with the first spool valve.

11. The material handling vehicle of claim 9, wherein the first anti-cavitation valve opens in response to a negative pressure in the first end of the first actuator such that fluid from the reservoir is drawn toward the first end of the first actuator through the first anti-cavitation valve by the negative pressure in the first end of the first actuator, and
wherein the second anti-cavitation valve opens in response to a negative pressure in the second end of the first actuator such that fluid from the reservoir is drawn toward the second end of the first actuator through the second anti-cavitation valve by the negative pressure in the second end of the first actuator.

12. The material handling vehicle of claim 9, wherein the first anti-cavitation valve is a check valve and is fluidly connected to a head side of the first actuator, and wherein the second anti-cavitation valve is a check valve and is fluidly connected to a piston side of the first actuator.

13. The material handling vehicle of claim 9, further comprising a third anti-cavitation valve fluidly positioned between the first end of the second actuator and the reservoir and a fourth anti-cavitation valve fluidly positioned between the second end of the second actuator and the reservoir.

14. The material handling vehicle of claim 13, wherein the third anti-cavitation valve opens in response to a negative pressure in the first end of the second actuator such that fluid from the reservoir is drawn toward the first end of the second actuator through the third anti-cavitation valve by the negative pressure in the first end of the second actuator.

15. The material handling vehicle of claim 14, wherein the fourth anti-cavitation valve opens in response to a negative pressure in the second end of the second actuator such that fluid from the reservoir is drawn toward the second end of the second actuator through the fourth anti-cavitation valve by the negative pressure in the second end of the second actuator.

16. A boom arm assembly configured to be pivotally connected to a material handling vehicle having a vehicle frame, the boom arm assembly comprising:
a boom arm having a first end and a second end, the boom arm configured to be connected to the frame adjacent the first end for rotation with respect to the frame;
an actuator configured to be connected to the vehicle frame and the boom arm for moving the boom arm with respect to the frame, the actuator including a first side and a second side;
a reservoir fluidly connected to the actuator;
a pump fluidly connected to the reservoir and to the actuator, the pump configured to direct fluid from the reservoir into the actuator;
a first valve fluidly positioned between the pump and the actuator to selectively direct fluid from the pump into the first side of the actuator while the first valve is in a first position and to direct fluid from the pump into the second side of the actuator while the first valve is in a second position;
a second valve fluidly positioned between the first side of the actuator and the reservoir, the second valve configured to permit fluid flow from the reservoir into the first side of the actuator while the second valve is open and to inhibit fluid flow from the first side of the actuator to the reservoir; and
a third valve fluidly positioned between the second side of the actuator and the reservoir, the third valve configured to permit fluid flow from the reservoir into the second side of the actuator while the third valve is open and to inhibit fluid flow from the second side of the actuator to the reservoir.

17. The boom arm assembly of claim 16, wherein the second valve opens in response to a negative pressure in the first end of the actuator such that fluid from the reservoir is drawn toward the first end of the actuator through the second valve by the negative pressure in the first end of the actuator.

18. The boom arm assembly of claim 16, wherein the third valve opens in response to a negative pressure in the second end of the actuator such that fluid from the reservoir is drawn toward the second end of the actuator through the third valve by the negative pressure in the second end of the actuator.

19. The boom arm assembly of claim 16, wherein the first valve is a spool valve, the second valve is an anti-cavitation check valve and the third valve is an anti-cavitation check valve.

20. The boom arm assembly of claim 16, wherein the second valve is fluidly connected to the first end of the actuator in parallel with the first valve, and wherein the third valve is fluidly connected to the second end of the actuator in parallel with the first valve.
